(19) United States
(12) Patent Application Publication
(10) Pub. No.: US 2014/0233041 A1
(43) Pub. Date: Aug. 21, 2014

(54) Computerized Movable Laser System for Radiographic Patient Positioning

(71) Applicants: Graham Reitz, Madison, WI (US); Gerald Fordyce, Madison, WI (US); William Butrymowicz, Madison, WI (US); Matt Orton, Oregon, WI (US); Joe Homp, Middleton, WI (US); Stephen P. Dechant, Lodi, WI (US)

(72) Inventors: Graham Reitz, Madison, WI (US); Gerald Fordyce, Madison, WI (US); William Butrymowicz, Madison, WI (US); Matt Orton, Oregon, WI (US); Joe Homp, Middleton, WI (US); Stephen P. Dechant, Lodi, WI (US)

(73) Assignee: GAMMEX, INC., Middleton, WI (US)

(21) Appl. No.: 14/007,146

(22) PCT Filed: Jul. 27, 2012
(86) PCT No.: PCT/US12/48663

§ 371 Date: Sep. 24, 2013

Related U.S. Application Data
(60) Provisional application No. 61/513,297, filed on Jul. 29, 2011.

(51) Int. Cl. G01B 11/00

(52) U.S. Cl. CPC G01B 11/002
USPC 356/614

(57) ABSTRACT

A system for radiographic patient positioning includes at least one laser. An orientation sensor is associated with a laser and the orientation sensor produces tilt data indicative of an orientation of a laser. A computer compares a later received tilt data from the orientation sensor to the stored tilt data to identify an error in the alignment of the laser. A method of operating a computer tomography patient positioning system includes providing a plurality of lasers and orientation sensors. A processor obtains tilt data from the orientation sensor of an associated laser and the tilt data is representative of an orientation of the associated laser. The processor compares new tilt data to the stored tilt data and identifies an error in an alignment of at least one laser of the plurality of laser units based upon the comparison of the new tilt data to the stored tilt data.

### BACKGROUND

The present disclosure relates to the field of radiographic imaging and therapy. More specifically, the present disclosure relates to a system for patient positioning for radiographic imaging, radiotherapy, and radiographic procedure simulation.

Radiographic imaging and therapy of a patient requires a precise alignment between the patient and the at least one radiographic source used in the procedure. In radiotherapy, a high dosage of radiation is delivered to a target location, exemplarily, a tumor isocenter. In order to minimize the exposure of healthy tissue to the radiation, simulations are performed using computed tomography (CT) to derive radiotherapy device settings and patient alignment that maximize radiation dose to the pathological target while minimizing radiation dose to other healthy tissue. Once the simulation is performed, the device settings and alignment coordinates are transferred to the radiotherapy device and a precise realignment between the patient and the radiotherapy device is required to accurately provide the radiotherapy.

Therefore, precision and repeatability of patient alignments within radiographic imaging and radiotherapy systems is desired.

### BRIEF DESCRIPTION OF THE DRAWINGS

FIG. 1 is an environmental view of an embodiment of a patient alignment system.

FIG. 2 is an environmental view of an alternative embodiment of a patient alignment system.

FIG. 3 is a schematic diagram of the software and controls for operation of the alignment system.

FIG. 4 is an isometric view of an embodiment of a laser unit for use in embodiments of the patient alignment system.

FIG. 5 is a sectional view taken long line 5-5 of the embodiment of the laser unit of FIG. 4.

FIG. 6 is a detailed view of an embodiment of a carriage of a laser unit.

FIG. 7 is a detailed view of a portion of the laser unit indicated by line 7-7 of FIG. 5.

FIG. 8 is a schematic diagram of the software and controls of safety and set-up features of the simulation system.

FIG. 9 is a flow chart that depicts an embodiment of a method of detecting the system axes.

FIG. 10 is a flow chart that depicts an embodiment of a method of alignment error detection.

FIG. 11 is an exemplary depiction of an embodiment of an arrangement of orientation sensors.

### DETAILED DISCLOSURE

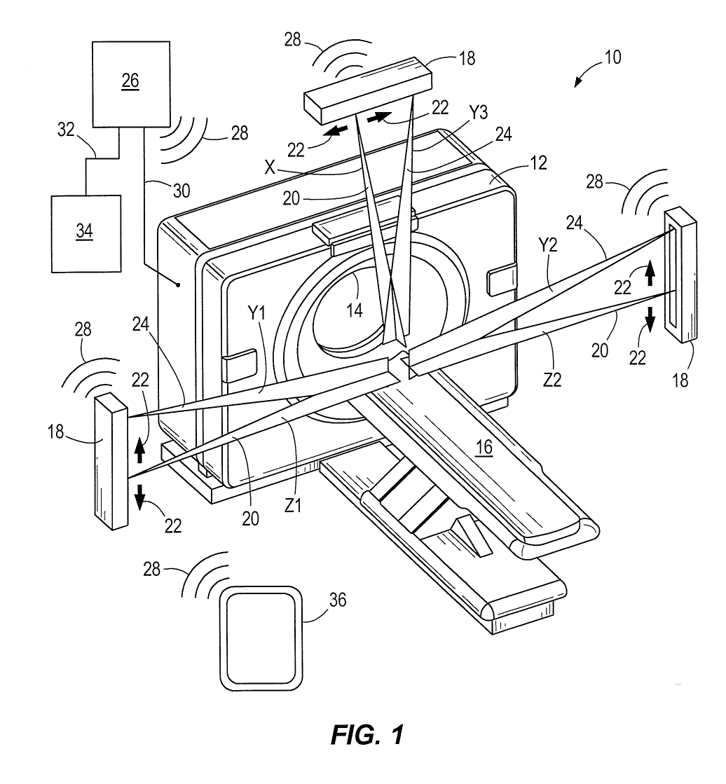

FIG. 1 is an environmental view of a computed tomography (CT) simulation system 10. The CT simulation system 10 is used in connection with a computed tomography (CT) imaging device 12. The CT device 12 includes one or more radiation sources (not depicted) that rotate within the CT device 12 about a circular gantry 14. The radiation sources of the CT device 12 are moved about the circular gantry 14 to project radiation as disclosed herein.

A patient is positioned on a movable gurney 16. The movable gurney 16 enables the positioning of the patient with respect to the CT device 12 in order to align a target region of the patient with the radiation sources.

Radiotherapy (e.g. radiation oncology) exposes a patient to a high degree of radiation energy. The radiation energy projected from a therapeutic radiation source is provided at a variety of orientations with respect to the patient. This minimizes the exposure of healthy patient tissue to the radiation energy, while maximizing a radiation dosage at the intersection of the projected radiation which is the target at the isocenter of the pathological or diseased tissue.

In order to maximize the effectiveness of the therapeutic radiation while minimizing the radiation dosage to healthy tissue of the patient, a simulation is performed using a CT device 12 to simulate the therapeutic radiation. Such a CT simulation of a radiation therapy procedure enables a clinician to optimize the alignment of the patient to maximize radiation dose to the isocenter of the target tissue, namely a tumor, while minimizing the radiation dose received by the surrounding healthy tissue.

The CT simulation system 10 includes one or more movable laser units 18. Such laser units 18 will be described in further detail herein. In the embodiment of the CT simulation system 10 depicted in FIG. 1, the movable laser units 18 each project at least one movable laser beam 20. In embodiments, the laser beams may be of a variety of shapes including, but not limited to those shapes that produce a line, a point, or a cross on the patient. The movable laser beams 20 projected from each of the movable laser units 18 are movable within the laser unit 18 in the direction of arrows 22. The laser beams 20 projected from the laser units 18 are adjustable along arrows 22 in order to align the projected laser beams 20 with a pathological region within the patient targeted to receive radiotherapy. The laser beams 20 are aligned with the pathological region such that the beams, but for the patient, would intersect at the isocenter of the pathological region.

In the embodiment of the CT simulation system 10 depicted in FIG. 1, the laser units 18 further project stationary laser beams 24. The stationary laser beams 24 are not otherwise adjustable beyond the laser calibration and axis detection as described herein, and are aligned at installation of the laser unit 18 such that each of the stationary laser beams 24 are coplanar. While not depicted in FIG. 1, in an alternative embodiment, the stationary laser beams 24 may be projected from one or more separate laser units rather than as an additional component combined with the movable lasers of the laser units 18 disclosed herein.

In the embodiment of the CT simulation system 10 depicted in FIG. 1, the laser units 18 are mounted to the walls and/or ceiling of a room dedicated for radiotherapy or radiotherapy simulation. Therefore, the specific configuration and positioning of the laser units 18 within such a system will be highly dependent upon the configuration of the room itself and the positioning of the CT device 12 and movable gurney 16 within the room. It is understood that such adjustments and configurations would be recognized by one of ordinary skill in the art with the disclosure as currently provided.

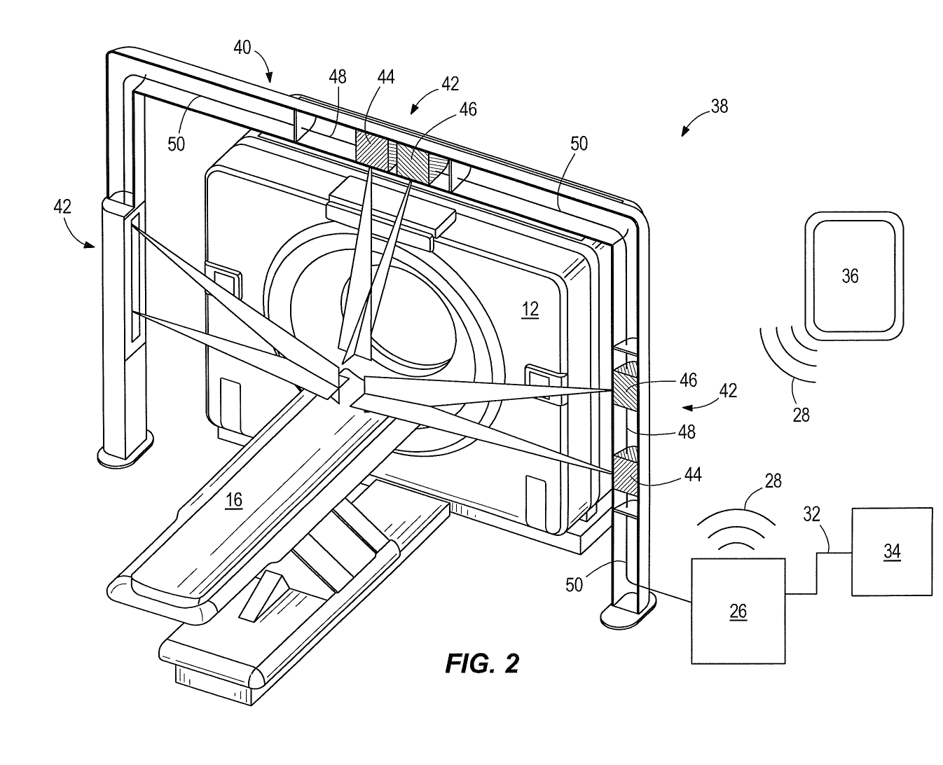

Embodiments of the CT simulation system as disclosed herein may be implemented with configurations using different numbers of laser units and projected laser beams. In a single movable laser embodiment, only an x-axis laser beam is projected to provide alignment in one dimension, while fixed lasers provide the Y and Z coordinates within which the patient is alienged by movement of the gurney. Other embodiments can use combinations of at least three, and exemplarily 5-10 movable and/or fixed lasers. In the embodiment depicted in FIGS. 1 and 2, six lasers provide alignment in three dimensions with the beams labeled X, Y1, Y2, Y3, Z1, and Z2.

A CT simulation computer 26 is communicatively connected to the CT device 12 and to each of the laser units 18. As exemplarily depicted, the CT simulation computer 26 is communicatively connected to the laser units 18 through the use of a wireless connection 28, which is exemplarily RF wireless data communication using exemplary protocols such as Wi-Fi or Bluetooth. A wired data connection 30 exemplarily connects the CT simulation computer 26 to the CT device 12. In embodiments, the CT simulation computer 26 may be an integral part of the CT device 12, or in other embodiments, the CT simulation computer 26 is a separate component that is independent from the CT device 12.

The CT simulation computer 26 includes one or more computer readable media (not depicted) upon which computer readable code is stored. The computer readable code, when executed, causes the CT simulation computer 26 to operate in the manner as disclosed herein, and to carry out the functions attributed to the CT simulation computer 26 as disclosed herein. In the embodiment, the CT simulation computer 26 is further communicatively connected with a network connection 32, which may be a local area network (LAN) or a wide area network (WAN), to a server 34. In the embodiments, the server 34 may include the computer readable medium that stores the computer readable code executed by the CT simulation computer 26 as disclosed above, alternatively, the server 34 may include additional information suitable for carrying out the processing functions as disclosed herein. One non-limiting example of the data that may be stored on the server 34 is a patient electronic medical record (EMR) that includes patient demographic information, diagnosis information, and treatment information. In still further embodiments, no server is present and the above disclosed information is locally stored at the CT simulation computer 26.

It is to be understood that one of ordinary skill in the art will recognize that the communicative connections as disclosed herein can be implemented in any of the variety of ways that communicative connections have been heretofor disclosed, as well as others known to persons of ordinary skill in the art that may be used to establish communicative connections.

While operating in the manner as disclosed in further detail herein, the CT simulation computer 26 requires input from clinicians or technicians using the CT simulation system 10. The CT simulation system 10 includes a user input device 36. The user input device 36 may be exemplarily integrated with the CT simulation computer 26 and the communicative connection between the user input device 36 and the CT simulation computer 26 may be a direct communication connection. As depicted in FIG. 1, the user input device 36 is a portable device, exemplarily a tablet computer that is communicatively connected to the CT simulation computer 26 with a wireless connection 28. It is to be understood that the user input device 36 may also include, but is not limited to other mobile devices such as laptops or smart phones. Embodiments of the user input device 36 may include a computer processor (not depicted), such that some or all of the operational controls of the user input device 36 reside with that device. In an exemplary embodiment, the user input device 36 presents a graphical user interface (GUI) on a graphical display to facilitate interaction with the clinician or technician.

FIG. 2 depicts an alternative embodiment of a CT simulation system 38. It is to be noted that reference numerals used in FIGS. 1 and 2 identify like components that are the same or substantially similar between the embodiments.

The CT simulation system 38 includes a stanchion 40 that supports laser units 42. The CT simulation system 38 differs from the CT simulation system 10 depicted in FIG. 1 in that rather than the laser units 18 being mounted to the walls and/or ceiling, the laser units 42 are retained within the stanchion 40. The stanchion 40 provides structure and support to hold the laser units 42 in alignment with respect to each other. In some embodiments, the stanchion 40 further holds the laser units 42 in alignment with respect to the CT device 12 and the movable gurney 16.

FIG. 2 depicts the stanchion 40 in a cut away view that shows the laser units 42 mounted within the stanchion 40. The laser units 42 include a movable laser 44 and a stationary laser 46. This is similar in arrangement to the laser units 18 depicted in FIG. 1. It is to be understood that in alternative embodiments, however, separate laser units 42 may be mounted around the perimeter defined by the stanchion 40 such that the movable lasers 44 and the stationary lasers 46 are separate units mounted within the stanchion 40. The movable lasers 44 are movable along a track or rail 48, as will be disclosed in further detail herein.

Wired connections 50 communicatively connect the laser units 42 to each other and to the CT simulation computer 26, such that each of the movable lasers 44 and stationary lasers 46 can be controlled and operated by a clinician or technician using the portable user input device 36.

The stanchion 40 is exemplarily constructed of extruded aluminum; however, it is understood that in alternative embodiments, the stanchion 40 is constructed of any of a variety of known materials or methods, including, but not limited to composite materials.

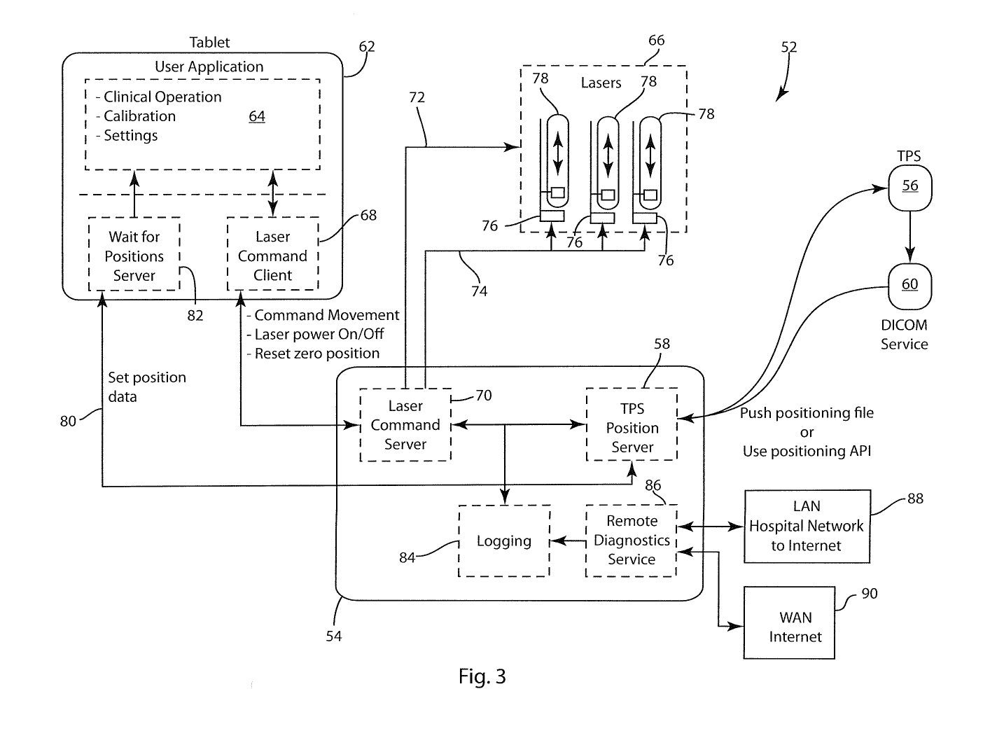

FIG. 3 is a system diagram of a CT simulation system 52 that depicts the interaction between the software and the hardware of the CT simulation system 52 such as to carry out the CT simulation functions of the system 52.

A microprocessor or computer processing unit (CPU) 54 is exemplarily a single board computer. In a further embodiment, the CPU 54 corresponds to the CT simulation computer 26 as depicted in FIGS. 1 and 2. The CPU 54 controls the general operation and coordination between the components of the CT simulation system 52.

The CPU 54 is connected to a treatment planning system (TPS) 56. The TPS 56 is a system or software that uses one or more techniques and models to plan a radiotherapy procedure for treatment of a patient. The TPS is often a software component or module provided by the radiotherapy device manufacturer, such that the models and technique used in the TPS are specific to the device that will be used to provide the radiotherapy. Third party TPS's are also available. The TPS collects the alignment and CT data collected during the CT simulation procedure and uses this data in planning the radiotherapy procedure. The TPS 56 communicates with a TPS position server 58 of the CPU 54 to acquire the alignment and position data provided by the CT simulation system 52 as further detailed herein. Both the TPS and the CPU 54 are in further communication with a Digital Imaging and Communications in Medicine (DICOM) standard based system or service 60 for storing and retrieving medical images of the patient.

The CPU 54 is further connected to a user interface 62 which is exemplarily embodied on a tablet computer such as user interface 36 shown in FIGS. 1 and 2. The user interface 62 is communicatively connected to the CPU 54, preferably with a wireless data communication connection. Embodiments of the user interface 62 include a processor (not depicted) and a computer readable media (not depicted) and the processor executes computer readable code stored on the computer readable medium to provide a graphical user interface (GUI) 64 to a clinician or technician that is performing the CT simulation procedure.

The GUI 64 prompts input from the clinician or technician such as to perform the necessary steps and controls required by the TPS 56, and also to control and operate the alignment lasers 66 as will be described in further detail herein with the laser command client 68. In embodiments, lasers 78 correspond to movable lasers 22 in FIGS. 1 and 2. The laser command client 68 is software (or a software module, or firmware) that provides instructions to a laser command server 70 of the CPU 54 to provide movement and operation commands to the alignment lasers 66. The laser command server 70 provides laser power signals 72 to the lasers, which turn the lasers on and off, or controls the intensity, color, or shape of the laser beams provided from the alignment lasers 66. In embodiments not depicted, the laser power signal 72 is also provided to stationary lasers (exemplarily lasers 24 of FIGS. 1 and 2). The laser command server 70 further provides a laser position signal 74 to the motors 76. The motors 76 and the operation thereof, will be described in further detail herein; however, the motors 76 receive the laser position signal 74 from the laser command server 70 and position the movable lasers 78 in order to provide alignment markings on the patient in accordance with the planned radiotherapy procedure.

The TPS position server 58 provides position data 80 to the user input interface 62. A position server module 82 holds the user interface application 64, until the radiotherapy planning process is undertaken by the TPS 56 and the position data 80 is provided from the TPS position server 58. The position data 80 provides initial position, set up, or calibration to coordinate the alignment lasers 66 of the CT simulation system 52 with the TPS 56.

The laser command server 70 controls the operation of the alignment lasers 66 through the laser power signal 72 and the laser position signal 74, but also receives confirmation back from the alignment lasers 66, including position data of the movable lasers 78. The position data will be described in further detail herein. The commands to the alignment lasers and the received laser position data is logged by a logging module 84 of the CPU 54.

A remote diagnostics service module 86 of the CPU 54 is accessed either locally through a local area network (LAN) 88, which is exemplarily a hospital network, or remotely via the Internet. In such an embodiment, a proximally located technician or device monitoring server within the physical hospital network can use the remote diagnostics service module 86 to access and review the data stored by the logging module 84 for either backup of the data from the logging module 84, or to check the operation of the CT simulation system 52 for auditing, quality review, accreditation, or other quality assurance procedures. In other embodiments, the remote diagnostics module 86 is accessed remotely using a wide area network (WAN) 90, exemplarily, the Internet.

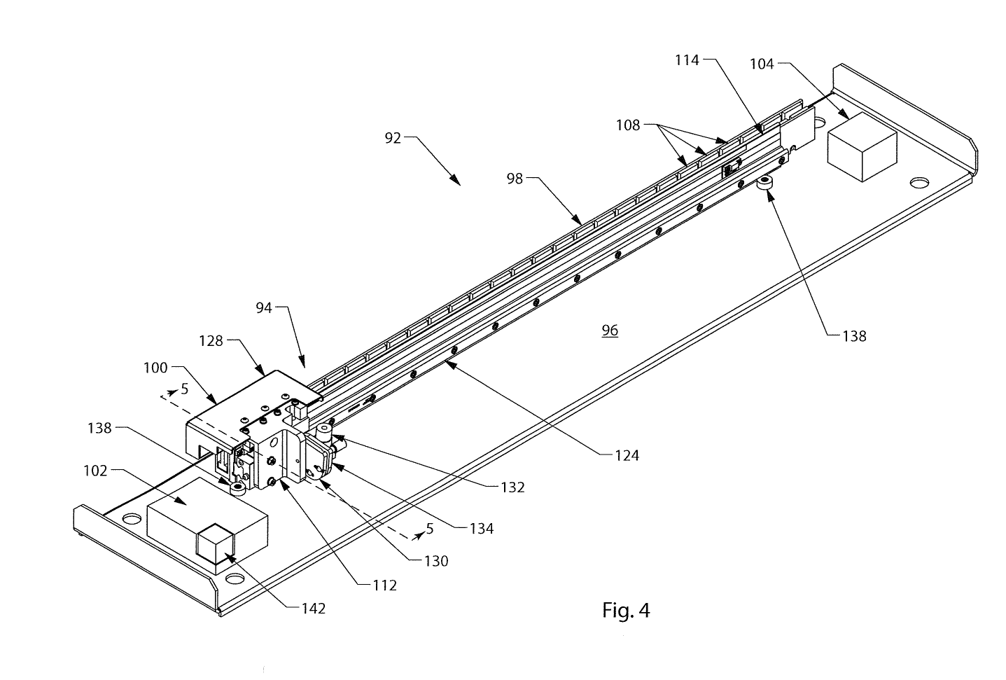

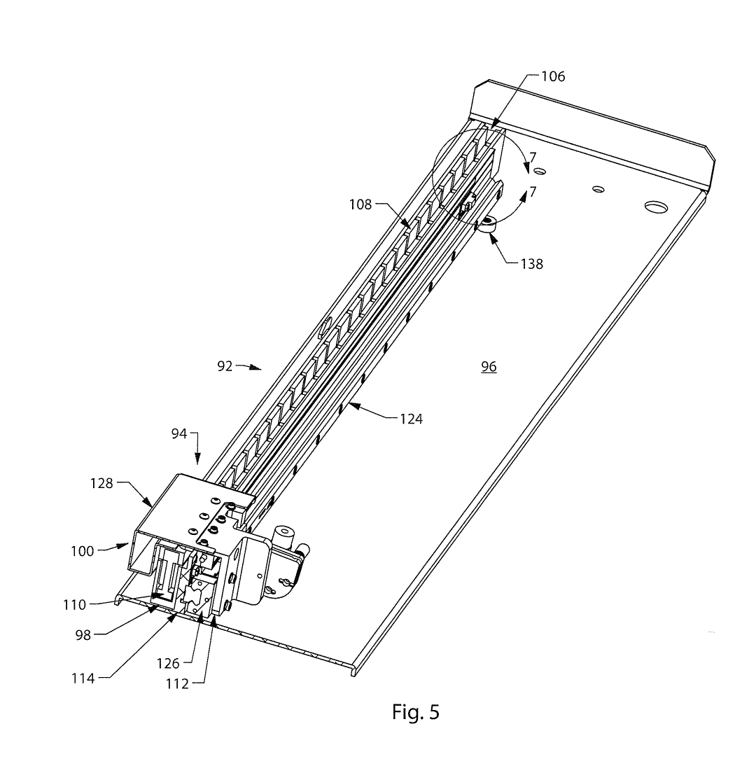

FIG. 4 is an isometric view of a laser unit 92 as used in embodiments of the CT simulation system as disclosed herein. The laser unit 92 is an exemplary embodiment of the laser units 18, 42, and 78 as described above with respect to FIGS. 1-3. FIG. 5 is a cut away view of the laser unit 92 taken along line 5-5 in FIG. 4. Like reference numerals between FIGS. 4 and 5 refer to the same structure in the two views.

The laser unit 92 includes a motor assembly 94 that is mounted to a back plate 96. The back plate 96 is configured to either secure to a wall, exemplarily in the embodiment described in reference to FIG. 1, or the back plate 96 is configured to be mounted within a stanchion, exemplarily depicted in the embodiment in FIG. 2.

The motor assembly 94 includes two general components, a stationary arm 98 and a carriage 100. The stationary arm 98 is mounted to the back plate 96 in a fixed relationship. In an embodiment, the stationary arm 98 runs a substantial length of the back plate 96. The carriage 100 moves as is described in further detail herein, along the stationary arm 98.

The laser unit 92 further includes a motor controller shown generally at 102. The motor controller 102 is generally a microprocessor or other controller that executes software or firmware according to received laser control signals from the laser command server (as depicted in FIG. 3). The motor controller 102 operates to translate these instructions into actions performed by the laser unit 92.

In embodiments of the laser unit 92 as disclosed herein, the laser unit 92 may further include a stationary laser generally depicted at 104 in FIG. 4. The stationary laser 104 produces an alignment beam projected along one stationary plane. This is exemplarily depicted by stationary beam 24 in FIG. 1. In contrast, the laser unit 92 operates to position a movable laser with the motor assembly 94 into alignment with an anatomical location on the patient.

As depicted in better detail in FIG. 5, the stationary arm 98 has a generally U-shaped configuration which defines a channel 106. A plurality of permanent magnets 108 are aligned within the walls of the channel 106 of the stationary arm 98.

The carriage 100 includes an electromagnet 110. The electromagnet 110 is suspended from a carriage bracket 112 in a position within the channel 106 and interposed between the permanent magnets 108. Electrical signals provided by the motor controller 102 control the polarity of the electromagnet 110 such that the carriage 100 can be driven along the stationary arm 98 by the sequential switching of the polarity of the electromagnet 108 within the magnetic fields of the permanent magnets 108.

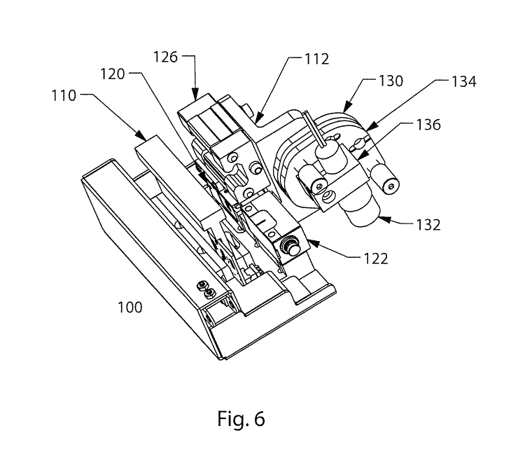

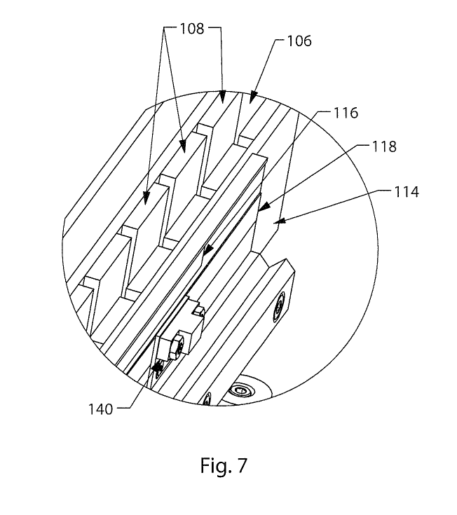

The stationary arm 98 further includes a mounting rib 114 that extends substantially along the length of the stationary arm 98. FIG. 7 is a close up view of the area 7-7 in FIG. 5. FIG. 7 shows a first encoder strip 116 and a second encoder strip 118 secured to the mounting rib 114. The first encoder strip 116 and the second encoder strip 118 include demarcations that indicate specific locations along the stationary arm 98. In an embodiment depicted in FIG. 6, a first read head 120 and a second read head 122 are secured to the carriage bracket 112 in a cooperative alignment with the first encoder strip 116 and the second encoder strip 118, respectively. In an embodiment, the first read head 120 and the second read head 122 are optical readers. As the carriage 100 is translated along the stationary arm, the first read head 120 and the second read head 122 translate the demarcations found on the first encoder strip 116 and the second encoder strip 118 into electrical signals that are provided back to the motor controller 102. The motor controller 102 uses these electrical signals to derive the position of the carriage 100 along the stationary arm 98.

As depicted in FIG. 5 a rail 124 is further secured to the stationary arm 98. A bearing 126 secured to the carriage bracket 112 engages the rail 124 and maintains the electromagnet 110, first read head 120, and second read head 122 of the carriage 100 in proper alignment with the permanent magnets 108, first encoder strip 116, and second encoder strip 118 of the stationary arm 98 as the carriage 100 translates along the stationary arm 98.

A cover 128 is secured to the carriage bracket 112. The cover 128 provides additional physical protection to the components of the electromagnet 110 and to the wires (not depicted) that connect the electromagnet 110, first read head 120, and second read head 122 to the motor controller 102. FIG. 6 is a more detailed view of an embodiment of the carriage 100 with the cover 128 removed.

As best depicted in FIG. 6, the carriage bracket 112 further includes a laser bracket 130. The laser bracket 130 can be a separate component that is secured to the carriage bracket 112, or may be integral with the carriage bracket 112. The movable laser 132 is secured to the laser bracket 130 with a laser mount 134. Laser adjustment clamps 136 are used to manually align and secure the movable laser 132 and laser mount 134 to the laser bracket 130 in relation to the laser unit 92. As described above with respect to FIGS. 1 and 2, in embodiments, the movable laser 132 produces a fan beam or line beam that is orthogonal to the direction of movement of the carriage 100 along the stationary arm 98. In addition, the fan beam projected from the movable laser 132 is orthogonal to a similar fan beam projected from the stationary laser 104. The result is that the laser unit 92 produces an alignment cross hair of the projected laser beams, with one axis of the cross hair being adjustable along the axis formed by the projected stationary beam.

Referring back to FIG. 4, the mounting rib 114 further includes a physical end stop 138 at either end of the translation path of the carriage 100. The physical end stop 138 may exemplarily be a rubberized bumper but is understood that a variety of other physical end stops or limit switches on the carriage 100 may be used to provide a limit signal back to the motor controller 102 to indicate that the carriage 100 has reached one terminus or another in a direction of travel along the stationary arm 98. Additionally, the mounting rib 114 includes a magnetic end stop 140 that serves a similar utility with a different configuration and modality of limit switch. It is understood that some embodiments may include one or both of the physical end stop 138 and magnetic end stop 140 (shown in FIG. 7), or alternatively may include any of another of a variety of end stops, including electrical or optical embodiments as would be recognized by a person of ordinary skill in the art in view of the present disclosure.

As will be described in further detail herein, the laser unit 92 includes a tilt sensor, exemplarily an accelerometer 142 (shown in FIG. 4). In one embodiment, the accelerometer 142 is a component of the motor controller 102, or the circuit board or other electronics associated with the motor controller 102. In an alternative embodiment, not depicted, the accelerometer 142 is mounted to a portion of the carriage 100, or in another location on the laser unit 92. The accelerometer 142 is exemplarily a three-axis accelerometer and gyroscope. In alternative embodiments, the accelerometer 142 is another type of tilt sensor, exemplarily an inclinometer. The accelerometer 142 provides tilt and orientation data to the motor controller 102, as will be described in greater detail herein.

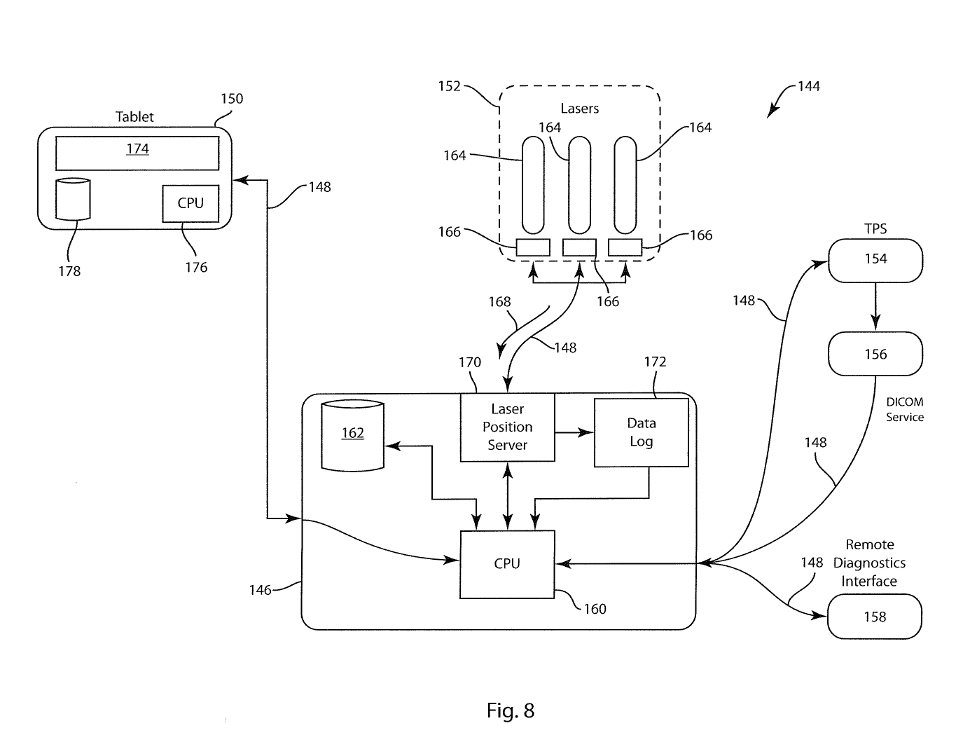

FIG. 8 is a schematic diagram of an embodiment of a CT simulation system 144. While the system diagram of the CT simulation system 52 depicted in FIG. 3 focused on the control and operation of the CT simulation system, the system diagram of the CT simulation system 144 depicted in FIG. 6 focuses on additional safety, set up, and quality assurance features found in embodiments of the CT simulation system 144.

Similar to the other embodiment of the CT simulation system described with respect to FIGS. 1-3, the CT simulation system 144 generally includes a CT simulation computer 146, which in embodiments, is a single board computer (SBC). The CT simulation computer 146 serves as a hub for data communication, control, and functions for the CT simulation system 144. The CT simulation computer 146 is communicatively connected with a plurality of data connections 148 to user input device 150, alignment lasers 152, TPS 154, DICOM service 156, and remote diagnostic interface 158. Each of these components are operationally described in further detail above with respect to FIGS. 1-3. The data connections 148 may include, but are not limited to, both wired and wireless data connections including, but not limited to RF, IR, and optical communications and communication protocols such as Wi-Fi, Bluetooth, and TCP/IP. It will be recognized by one of ordinary skill in the art in view of the present disclosure that these examples are not limiting on the communication platform and protocols that may be used as the data connections 148 within embodiments of the CT simulation system 144.

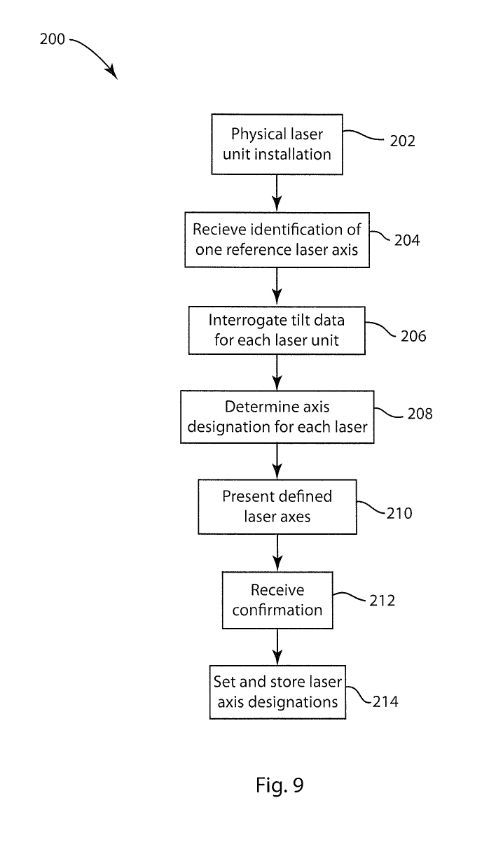

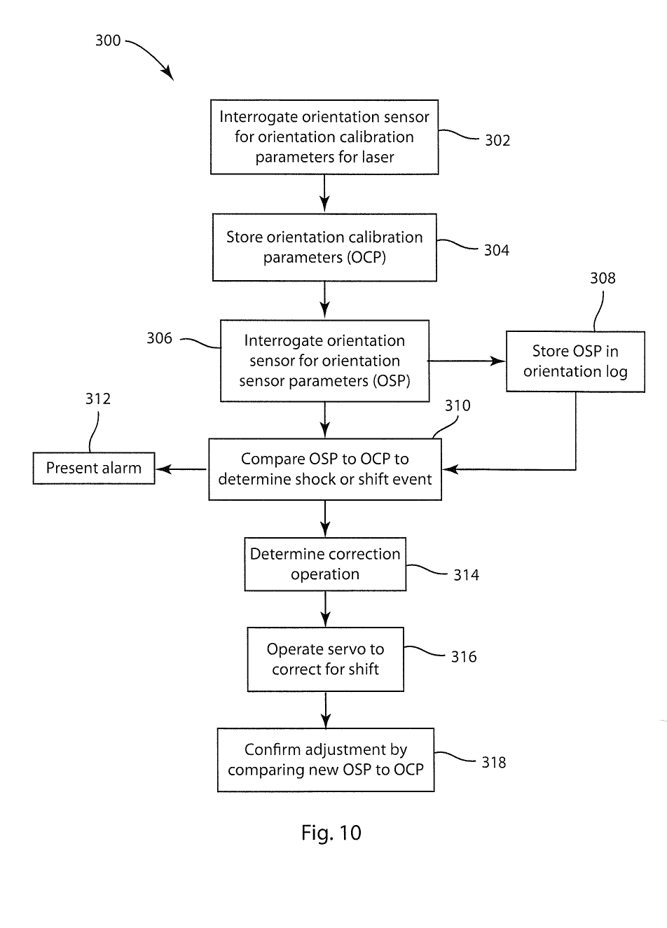

The CT simulation computer 146 includes a CPU 160, which may alternatively be a microprocessor or microcontroller, that is communicatively connected to a computer readable medium 162. Computer readable code that embodies software or software modules is stored upon the computer readable medium 162 such that the CPU 160 accesses the computer readable code on the computer readable medium 162 and executes the computer readable code to carry out the functions as described herein, embodiments of which are described in further detail with respect to the flow charts of FIGS. 9 and 10.

As described above, each of the laser units 164 of the alignment lasers 152 include a motor controller 166. The motor controllers 166 collect position data from the interaction of the at least one read head with the at least one encoder strip that identifies a position of the movable laser. Additionally, the motor controller 166 receives tilt data from the accelerometer that provides information regarding the tilt, orientation, and alignment (collectively “tilt data”) of each of the laser units 164. This position and tilt data 168 is provided to a laser position server 170 of the CT simulation computer 146. The laser position server 170 stores the position and tilt data in a data log 172 and also provides the position and tilt data to the microprocessor 160 for use in executing the software stored on the computer readable medium 162, as will be described in further detail herein.

The user input device 150, which, in the embodiment depicted, is a portable computer such as a tablet computer, is communicatively connected through the data connection 148 to the CT simulation computer 146. The user input device 150 includes a graphical display 174. It is understood that the graphical display 174 can also provide user input functionality if the graphical display 174 is touch screen graphical display. Alternatively, the user input device 150 includes other features and functionality to receive user input (not depicted) exemplarily, these can include a keyboard or a mouse. The user input device 150 further includes a CPU 176 that is communicatively connected to both the display 174 and to a computer readable medium 178. The computer readable medium 178 is programmed with a computer readable code that is accessed and executed by the CPU 176 in order to operate the user input device 150 to present a graphical user interface (GUI) on the graphical display 174. The GUI presented on the graphical display 174 provides a prompt for a clinician or technician to enter input as required in the processes to be described in further detail herein as well as operates to present notifications to the clinician or technician as a result of the processes as described in further detail herein.

FIG. 9 is a flow chart that depicts an embodiment of a method 200 of configuring a CT simulation system, of which the CT simulation system 144 as depicted in FIG. 6 will be exemplarily used in connection with the description of the flow chart of the method 200. The method 200 begins with the completion of the physical installation of the laser units. As described above, the laser units may be installed by securing them to respective walls and/or the ceiling of a room which is being configured for providing CT simulations for radiotherapy planning. Alternatively, the laser units may be installed within a stanchion that provides secure, standardized, and repeatable laser unit positioning that is independent from the specific configuration of the room. As disclosed above, the lasers installed may include one or more of movable lasers, stationary lasers, or laser units that include a combination of one or more movable and/or stationary lasers.

Upon completion of the physical installation of the laser units at 202, features of the method 200 are executed by the CPU 160 and the GUI presented on the graphical display 174 prompts the installing technician to identify one laser unit 164 with an identified axis. In one embodiment, the installing technician may provide an input that the lasers will define a Cartesian coordinate system (e.g. x (horizontal), y (horizontal and perpendicular to x-laser), z (vertical)). In some embodiments, at 204, the installing technician may identify one reference axis represented by an entire laser unit, in alternative embodiments in which multiple lasers are contained within a single laser unit, the installing technician may identify one reference axis projected by a portion of the lasers in one of the laser units (e.g. Y1, Y2, Z1, Z2).

In an alternative embodiment, one or more orientation sensing devices provide tilt data, as will be explained in greater detail herein, to the CT simulation computer which allows the computer to automatically identify each laser axis during set up (once mounted correctly) without requiring the installer to manually input a reference axis.

Next, at 206, the tilt data for each laser unit is interrogated. In the CT simulation system 144 depicted in FIG. 6, the CPU 160 operates the laser position server 170 to acquire position and tilt data 168 from each of the motor controllers 166 respectively associated with each of the laser units 164. As noted above, the position and tilt data 168 exemplarily includes tilt data acquired from an orientation sensing device, such as a three-axis accelerometer associated with each of the laser units 164. Additionally, or alternatively, each of the laser units 164 can further include a three-axis inclinometer. In still further embodiments, fewer axes of sensing are required. Therefore, the CPU 160 receives tilt data that identifies an alignment and orientation of the accelerometer or inclinometer between each of the newly installed laser units.

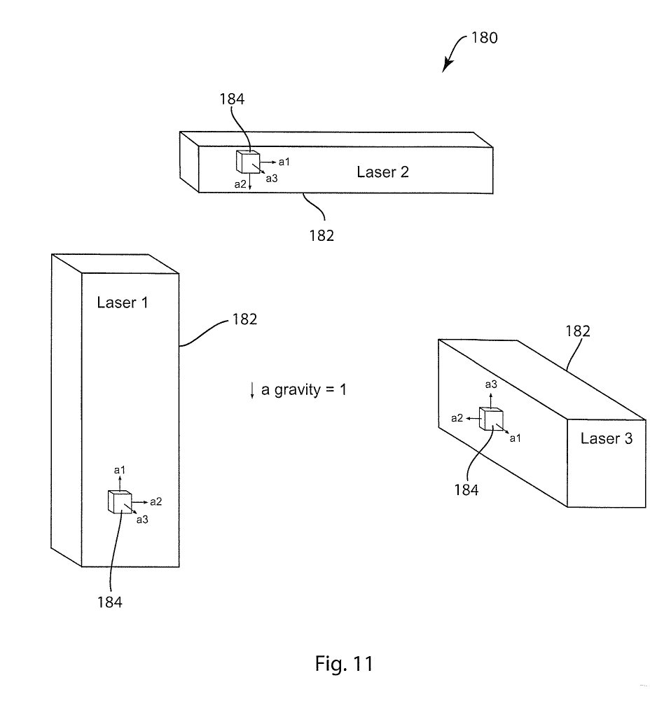

With reference to FIG. 11 the tilt data will be described in greater detail. In an embodiment, the tilt data received by the CPU from the orientation sensing device is one or more numerical values representative of a static acceleration due to gravity in one or more coordinate axes. FIG. 11 depicts an exemplary laser system 180 with three lasers 182. It is understood from the description above that the lasers of the laser system 180 can be a combination of movable and/or stationary lasers. Each of the lasers 182 includes an orientation sensor 184 which, as described above, may exemplarily be an accelerometer or an inclinometer. The orientation sensors 184 produce a signal that is a numerical value equivalent to a force sensed in each coordinate direction. The force of gravity acts upon each of the orientation sensors 184 and the orientation sensors 184 are calibrated such that a signal of a numerical value of 1 is produced if the gravity aligns with one of the coordinate axes. It is to be understood that if the orientation sensor does not have an axis aligned with the force of gravity, then signals with numerical values different from 1 or 0 will be produced for multiple axes from the orientation sensor.

At 208 the CPU 160 analyzes the tilt data in the form of the signals from the orientation sensor to determine a laser axis designation for each laser. As shown below in Table 1, each laser position has a tilt signature that reflects the gravity sensed by a respective orientation sensor 184 if the laser 182 is that position. In embodiments, system computer 146 could automatically check that no laser has been mounted in the wrong orientation by comparing a calibrated laser axis designation with the tilt signature defined by the tilt data from that laser unit. For example, the system could detect by comparison that two or more lasers have been mounted in the X orientation.

TABLE 1
Tilt Signatures

| Laser | A1 | A2 | A3 |
|---|---|---|---|
| 1 | −1 | 0 | 0 |
| 2 | 0 | 1 | 0 |
| 3 | 0 | 0 | −1 |

As noted above, various embodiments may employ one, three, five, or more lasers. In embodiments, an orientation sensor is associated and aligned with each laser in the system. The received tilt data from 206 indicates to the CPU the number of lasers in the system that require an axis designation. In embodiments that received an identification of a reference laser, that reference laser axis is used to associate an alignment and orientation of the reference laser with a tilt signature from the tilt data. After identifying the orientation and alignment of the reference laser and the associated axis designation, the tilt data from the remaining lasers can be compared based upon the orientation and alignment identified by the tilt data to derive each of the axes represented by the beams projected from the remaining lasers in the CT simulation system.

At 210 the graphical user interface presented on display 174 is operated to present the axes identified for the lasers in the system to the installing technician. In an embodiment, the GUI further prompts the installing technician to review, verify, and confirm the laser axes as defined by the CPU. A confirmation of the automatedly identified laser axes is received at 212 from an input by the installing technician into the user input device 150. After the automatedly identified axes designations are confirmed, then the CPU sets and stores the laser axis designations either in its own memory, external storage memory, or at the laser position server at 214. The microprocessor can then use and rely upon these laser axis designations for later operation of the CT simulation system 144 by sending a position signal to a specified laser unit as explained above with respect to FIG. 3, to control the position of a laser identified by the stored laser axis designation.

In an alternative embodiment, the automated laser axis determination can be automatedly performed and monitored. Orientation sensing devices, exemplarily noted above as an accelerometer or an inclinometer, measure the static acceleration of gravity and thereby provide tilt and orientation sensing capabilities to computerized devices. As disclosed above, these sensors can be integrated into the electronics of the laser unit. In some embodiments, the sensor is a part of the application specific circuit board that is exemplarily the motor controller, while in alternative embodiments, such a sensor may be attached to the laser unit itself.

An orientation sensing device, as described above, can provide a tilt data that provides an identifiable tilt signature associated with each of the standard positions of the lasers configured in the CT simulation system. While the tilt signatures are herein generally referred to conceptually with reference to “horizontal,” “vertical,” or “vertical-inverted,” these are presented as alternative conceptual representations of the tilt signatures disclosed above based upon the numerical values as obtained from the orientation sensors. As described above, embodiments of the CT simulation system can include an orientation sensor associated with each laser in the system. An exemplary five laser system includes lasers representative of the X, Y1, Y2, Z1, and Z2 axes. A tilt signature provided by the orientation sensing devices are distinguishable between laser units wherein the system is assembled, and the distinctive tilt signatures identify each of the coordinate axes. Therefore, the system can compare the tilt signatures in order to automatedly determine the axes represented by each laser upon setup without a need for the additional input by a technician.

As an example, an exemplary orientation sensor provides three relative orientation indications (Aₓ, A_{y}, and A_{z}) for each laser in a five axis laser system. The Table 2 below provides the tilt signatures associated with each of the laser axes.

TABLE 2

| Axis | Aₓ | A_{y} | A_{z} |
|---|---|---|---|
| X | horizontal | vertical | horizontal |
| Y1 | horizontal | vertical-inverted | horizontal |
| Y2 | horizontal | vertical-inverted | horizontal |
| Z1 | vertical | horizontal | horizontal |
| Z2 | vertical | horizontal | horizontal |

Upon setup and configuration, the computer matches the received tilt signatures from the reading off of the orientation sensing device and compares that tilt signature to the definitions found in Table 2 above in order to define an axis associated with each laser. It is to be noted that, in some embodiments, laser axes provided by coordinated lasers (e.g. Y1, Y2 or Z1, Z2) would only require a single orientation sensing device and tilt signature since the coordinated laser pairs for these axes are operated together by the CT simulation computer.

Further features that are obtained from embodiments of the system and method as described herein are that once the laser axes have been defined, the tilt data for each laser unit can be stored and comparatively re-checked to confirm that the laser unit is still in the original orientation. This provides an additional safety feature to automatedly check that a laser unit has been returned to the proper orientation, such as after removal for maintenance. In a still further embodiment, the analysis of the tilt signature provides a confirmation of proper basic installation, by determining that the identified tilt signature associated with each of the lasers meet the axis definitions for each of the required laser axes in the system.

FIG. 10 is a flow chart that depicts an embodiment of a method 300 of detecting alignment errors, such as shock or shift events, in of any of the laser units in a CT simulation system. It is to be understood that in embodiments, method 200 and method 300 are related in that method 200 can be performed to set up, install, or calibrate the laser units of CT simulation system, while method 300 is performed after such set up, installation, or calibration has been completed. To this end, the tilt data used to identify the tilt signatures and axis designations as described above, with particular reference to Table 1 and FIG. 11, can be further leveraged for alignment error detection post setup. The method 300 begins with an assembled and calibrated CT simulation system as described above. In the CT simulation system, an orientation sensor, as described above, is associated with each of the lasers in the system. At 302, the orientation sensors are interrogated by a processor operating in the CT simulation system to obtain orientation calibration parameters (OCP) for each laser. As explained above, the OCP can exemplarily be numerical values obtained from one or more of the orientation sensors, such numerical values being associated with a relative orientation. In an exemplary embodiment used in the present description, the orientation sensor will be a three-axis orientation sensor and therefore three orientation calibration parameters (exemplarily Aₓ, A_{y}, A_{z}) will be received. However, it is understood that in alternative embodiments, one or two axis orientation sensors may be used. In some embodiments, the OCP may be obtained as a result from the set up and axis configuration and calibration of the method 200.

At 304, the received orientation calibration parameters are stored within the static memory of the CT simulation computer or on another computer readable medium communicatively connected to the CT simulation computer. Once the orientation calibration parameters are stored at 304, the CT simulation system interrogates the orientation sensors for renewed orientation sensor parameters (OSP) at 306. As with the OCP, the OSP can be numerical values obtained from one or more of the orientation sensors. The received orientation sensor parameters are stored in an orientation sensor log at 308. It is to be understood that when the CT simulation system is in use, such continued interrogation of the orientation sensors may be done in the background as the other functions and features as disclosed above are carried out by the system. If the CT simulation computer is continuously powered, then the interrogation of the orientation sensors for orientation parameters can continue even while the CT simulation system is not actively being used. Furthermore, if battery backup (not depicted) is added to the system, then even during times when the CT simulation system is without power, then the orientation sensor parameters can be stored in the orientation sensor log at 308 for later analysis.

In embodiments, the orientation sensor is interrogated for tilt data continuously, in real time, or near-real time. Alternatively, the orientation sensor is interrogated for tilt data at regular intervals (exemplarily every second, minute, or hour), or the orientation sensor is interrogated upon an event such as initialization of the CT simulation system or the start of a procedure.

As noted above, generally, when the lasers and associated orientation sensors are properly installed and set up, then the tilt data will show a normalized value (exemplarily 1) in one of the axis directions of the orientation sensor. However, a shock, such as caused by another piece of medical equipment accidentally striking one of the laser units, will create an acceleration component in one or more of the other axis directions, showing up in the monitored tilt data. If the shock, resulted in a permanent shift of the laser unit, then the tilt data will reflect the gravitational acceleration as components along two or more of the orientation sensor axes.

At 310, the orientation calibration parameters stored at 304 are compared to the interrogated orientation sensor parameters either from 306 or from the orientation sensor log as stored in 308. The comparisons of the stored orientation calibration parameters to the interrogated orientation sensor parameters are used to determine whether the lasers of the system are still in the same alignment as when the system was configured and calibrated, or whether one or more of the lasers of the CT simulation system have suffered from a shock or a shift event.

As used in the present disclosure, a shock event is referred to as an event wherein the continuously interrogated orientation sensor parameters change for a particular laser, but return to match the stored orientation calibration parameters. On the other hand, a shift event is determined to occur when an identified change in the orientation sensor parameters is followed by the orientation sensor parameter remaining at the new, shifted value. Both events are indicators of error sources in the CT simulation system, and therefore, at 312 an alarm is provided to a clinician or technician that identifies the type of event and/or a suggested response. In a shock event, while the orientation sensor parameter may indicate that the laser is not out of alignment, there is a chance for other forms of damage or error introduced into the CT simulation system due to the shock event and therefore it may be recommended to the clinician or technician to run further system diagnostics. In one embodiment, the change in the tilt data is compared relative to a sensitivity threshold, which may be a threshold that is adjustable by the clinician or technician. By establishing a sensitivity threshold, some minor sources of noise in the tilt data can be avoided resulting in fewer false alarms.

If the shock or shift event is detected while the CT simulation system is in use, the alarm may be provided visually or audibly at the time that the event is detected. Alternatively, if the shock or shift event occurred while the CT simulation system was off or not actively operating, then upon initialization or boot-up of the CT simulation system, the comparison analysis from 310 will be conducted on the orientation sensor parameter stored in the log at 308 and an alarm is provided upon initialization.

If a shift event is detected at 310, then the alarm provided at 312 can indicate that the lasers must be recalibrated to ensure accurate patient alignment. In a still further embodiment, servo motors (not depicted) associated with each of the lasers in the CT simulation system allow for the CT simulation system to correct the positioning of one or more of the lasers in the event of a detected shift event. At 314, a correction operation required to return the laser to an orientation such that the orientation sensor parameters match the stored orientation calibration parameters is determined. At 316, the one or more servo motors are operated to adjust the alignment and orientation of one or more of the lasers in order to correct for the detected shift event. The completion of the adjustment is confirmed at 318 by comparing new orientation sensor parameters interrogated from the orientation sensor to the previously stored orientation calibration parameter.

It is to be understood that the method 300, as described above, can be performed in a variety of manners, as would be recognized by a person of ordinary skill in the art in view of this disclosure, including performing the method 300 in an alternative order than depicted in FIG. 10 or performing the method 300 for any number of lasers in the CT simulation system.

The present disclosure has focused on the specific application of CT simulation of a radiotherapy procedure; however, the systems and methods as disclosed herein may also be used for patient alignment in other radiographic procedures, including radiotherapy and radiographic imaging.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for radiographic patient positioning, the system comprising:
at least one laser unit that includes at least one laser that projects a laser beam;
an orientation sensor associated with the laser, the orientation sensor produces tilt data indicative of an orientation of the laser;
a computer communicatively connected to the orientation sensor, wherein the computer receives the tilt data from the orientation sensor, stores the received tilt data from the orientation sensor in a computer readable medium, and compares a later received tilt data from the orientation sensor to the stored tilt data to identify an error in the alignment of the laser.

2. The system of claim 1, wherein the computer receives the tilt data in real time, and the computer initiates an alarm indicative of a shock event if the later received tilt data deviates from the stored tilt data by more than a predetermined threshold and later returns to within the predetermined threshold of the stored tilt data.

3. The system of claim 1, wherein the computer initiates an alarm indicative of a shift event if the later received tilt signature is different than the stored tilt signature.

4. The system of claim 1, wherein the laser unit is a plurality of laser units and at least one laser is movable within a laser unit of the plurality, and further comprising:
a motor assembly within the at least one laser unit, the motor assembly comprising:
a stationary arm with a channel along the length of the stationary arm, the channel being lined with magnets;
a carriage movably secured to the stationary arm and an electromagnet suspended from the carriage within the channel between the magnets of the channel and the laser is secured to the carriage; and
a controller communicatively connected to the laser, the controller operates the electromagnet to move the carriage along the stationary arm.

5. The system of claim 4, wherein the computer identifies an axis represented by the laser from the tilt data received from the orientation sensor and the computer uses the identified axis to move the laser through the controller.

6. The system of claim 4, wherein the at least one laser is a first laser and the at least one laser unit further comprises a second laser fixedly mounted to the at least one laser unit and the second laser produces a laser beam oriented in a direction orthogonal to the laser beam produced by the first laser.

7. The system of claim 6, wherein the at least one laser unit is three laser units oriented about the patient such that each of the second lasers in each of the laser units produce laser beams that are co-planar, and each of the first lasers produce laser beams orthogonal to each of the laser beams produced by the second lasers.

8. The system of claim 7, wherein the three laser units are mounted in a stanchion and the stanchion maintains each of the laser units in alignment relative to each of the other laser units.

9. The system of claim 4, further comprising:
at least one encoder strip secured to the stationary arm, the at least one encoder strip comprising a plurality of demarcations; and
at least one read head secured to the carriage, the at least one read head translates along the stationary arm with the carriage and converts the plurality of demarcations into an electrical signal provided to the computer, wherein the electrical signal provided to the computer is indicative of the position of the carriage along the stationary arm.

10. The system of claim 1, wherein the at least one laser unit is at least three laser units, and the orientation sensors of the laser units produce tilt data and the computer identifies an axis represented by each of the laser units based upon the received tilt data.

11. The system of claim 1, wherein the orientation sensors detect static acceleration of gravity on the sensor in three axes, and the received tilt data is representative of the static acceleration of gravity detected by the orientation sensor.

12. The system of claim 11, wherein the tilt signature signals comprise one or more normalized numerical values representative of the static acceleration of gravity on the orientation sensors.

13. A method of operating a computed tomography patient positioning system, the method comprising:
providing a plurality of laser units, each of the plurality of laser units comprising at least one laser and an orientation sensor;
obtaining, with a processor, tilt data from the orientation sensor of an associated laser, the tilt data being representative of an orientation of the associated laser;
storing the received tilt data on a computer readable medium communicatively connected to the processor;
receiving new tilt data with the processor from each of the orientation sensors;
comparing, with the processor, the new tilt data to the stored tilt data; and
identifying an error in an alignment of at least one laser of the plurality of laser units based upon the comparison of the new tilt data to the stored tilt data.

14. The method of claim 13, further comprising initiating an alarm indicative of a shift event if the new tilt data is different from the stored tilt data.

15. The method of claim 13, further comprising:
receiving, with the processor, the new tilt data from the orientation sensors in real time;
determining, with the processor, if the new tilt data is different than the stored tilt data;
determining, with the processor if the new tilt data returns to match the stored tilt data; and
initiating an alarm indicative of a shock event.

16. The method of claim 13, further comprising:
deriving, with the processor, an axis designation of each laser of the plurality of laser units from the obtained tilt data;
storing the axis designation of each laser in a computer readable medium communicatively connected to the processor.

17. The method of claim 16, further comprising:
presenting on a graphical display the axis designation of each laser of the plurality of laser units; and
receiving a confirmation input with the processor, wherein the axis designation of each laser is stored upon receipt of the confirmation input.

18. The method of claim 16, further comprising:
providing a position signal from the processor to a laser unit of the plurality of laser units, wherein the processor identifies the laser unit to be provided the position signal based upon the stored axis designation; and
operating the laser unit to change the position of the lasers according to the received position signal.

19. The method of claim 13, further comprising detecting a static acceleration of the each of the orientation sensors due to gravity along three axes, and wherein the tilt data provided by each orientation sensor comprises at least one numerical value of the detected static acceleration.

20. The method of claim 13, further comprising:
calculating a correction operation with the processor; and
operating one or more of the lasers according to the correction operation to adjust one or more of the lasers to correct for the identified error in the alignment of at least one laser.
